(19) United States
(12) Patent Application Publication
(10) Pub. No.: US 2007/0012717 A1
(43) Pub. Date: Jan. 18, 2007

(54) Part feeder

(75) Inventors: Tadashi Hanaoka, Mie (JP); Shuichi Maruyama, Mie (JP); Toshirou Higuma, Mie (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 11/485,279

(22) Filed: Jul. 13, 2006

(30) Foreign Application Priority Data
Jul. 15, 2005 (JP) 2005-206858

(51) Int. Cl. A01K 61/02; B65H 5/00; B21F 45/18

(52) U.S. Cl. 221/236; 119/56.1; 29/408

(57) ABSTRACT

A part feeder for feeding at least one part having a through hole from a standby position to a predetermined position includes a holding device, a transport mechanism, and a measuring device. The holding device has a rod disposed in a horizontal position. The holding device is adapted to hold the at least one part in suspension with the rod inserted through the through hole of the at least one part. The transport mechanism is adapted to move the holding device holding the at least one part in suspension from the standby position to the predetermined position. The measuring device is adapted to measure a thickness of the at least one part held by the holding device.

### CROSS-REFERENCE TO RELATED APPLICATION(S)

This application claims the foreign priority benefit under Title 35, United States Code, § 119 (a)-(d), of Japanese Patent Application No. 2005-206858 filed on Jul. 15, 2005 in the Japan Patent Office, the disclosure of which is herein incorporated by reference in its entirety.

### BACKGROUND OF THE INVENTION

This invention relates to a part feeder for feeding a part having a through hole from a standby position to a predetermined position.

A variety of part feeders for feeding at least one part having a through hole from a standby position to a predetermined position have been proposed. For example, disclosed in JP 8-1568 A (see Paragraphs 0020-0021; FIGS. 1 and 6) is a part feeder which includes a holding device and a robot. The holding device illustrated therein has a rod disposed in a horizontal position, and is adapted to carry a plurality of discs with the rod inserted through the center holes of the discs so that the discs are held in suspension on the rod. The holding device having picked up the discs placed in a conveyor container (standby position) and holding the discs in suspension is moved by the robot to a location above a washing container (predetermined position). The discs are then fed into the washing container.

The above setup as is typically the case with conventional part feeders would allow an irregular part different in thickness from regular parts, which could be included in the parts placed in the standby position, to be fed to the next stage in the predetermined position, and thus require an extra operation of temporarily stopping a subsequent step in order to remove the irregular part, which would disadvantageously impair the production efficiency.

Therefore, there is a need to eliminate the above disadvantage, and it would be desired to provide an improved part feeder which can selectively feed regular parts detected among the parts placed in a standby position to a predetermined position, even if the parts in the standby position possibly include irregular parts different in thickness from the regular parts.

Illustrative, non-limiting embodiments of the present invention overcome the above disadvantage and other disadvantages not described above. Also, the present invention is not required to overcome the disadvantage described above, and an illustrative, non-limiting embodiment of the present invention may not overcome any of the problems described above.

### SUMMARY OF THE INVENTION

In one aspect of the present invention, a part feeder for feeding at least one part having a through hole from a standby position to a predetermined position is provided. The part feeder includes a holding device, a transport mechanism, and a measuring device. The holding device has a rod disposed in a horizontal position. The holding device is adapted to hold the at least one part in suspension with the rod inserted through the through hole of the at least one part. The transport mechanism is adapted to move the holding device holding the at least one part in suspension from the standby position to the predetermined position. The measuring device is adapted to measure a thickness of the at least one part held by the holding device.

In this arrangement, since the thickness of the at least one part held in suspension on the rod of the holding device is measured by the measuring device, any irregular parts different in thickness from other regular parts can be detected during the process of feeding the parts from the standby position to the predetermined position, and thus the regular parts alone can be fed to the predetermined position.

In one exemplary embodiment, optionally, the transport mechanism of the above part feeder may include means for causing the rod with the at least one part to be horizontally swung toward the measuring device, in a manner that centrifugally brings the at least one part to a distal end of the rod. In this embodiment, the thickness of the at least one part measured by the measuring device may include a totalized thickness of a plurality of the parts brought together at the distal end of the rod.

In this arrangement, the plurality of parts may be brought together at the distal end of the rod with no clearance left between adjacent parts, and thus the totalized thickness of the plurality of parts can be measured by the measuring device with accuracy. In addition, an outer cylindrical surface of the rod, especially an upper side thereof, may preferably be formed with a smooth surface free of irregularities so that the plurality of parts may smoothly slide toward the distal end of the rod by centrifugal force.

In another exemplary embodiment, additionally or alternatively, the holding device may include a detection unit adapted to detect a part placed in the standby position. Provision of such a detection unit in the holding device makes it possible to prevent failure to feed any part remaining in the standby position. The detection unit may be integrally provided in the holding device, so that disadvantageous upsizing of the part feeder in its entirety can be avoided and a compact structure can be achieved.

In yet another exemplary embodiment, additionally or alternatively, the holding device may include an antisway mechanism adapted to come in close proximity to the at least one part held in suspension with the rod inserted through the through hole of the at least one part in order to prevent the at least one part from swaying. Provision of such an antisway mechanism in the holding device serves to reduce or minimize the swaying motion of the at least one part held in suspension. Accordingly, the measuring device can start measuring the thickness of the at least one part irrespective of the swaying motion of the at least one part (without the need for waiting until the at least one part stops swaying), so that the time required for measurement can be reduced. Since the antisway mechanism is adapted to come in close proximity to the at least one part, the antisway mechanism may be designed so as not to press against the at least one part. In this embodiment, the at least one part may smoothly slide toward the distal end of the rod by centrifugal force generated particularly when the rod with the at least one part is swung horizontally toward the measuring device.

In yet another exemplary embodiment, additionally or alternatively, the at least one part may comprise a long member having a first end and a second end such that the through hole is provided at the first end of the long member, and the holding device may include means for raising the long member laid in the standby position in a slanting upward direction whereby the long member gradually rises with the second end unmoved and is lifted up to a vertically suspended position. Since the at least one part (long member) may gradually rise with the second end unmoved and be lifted up while it is being brought into the vertically suspended position, the swaying motion of the at least one part held in suspension can be reduced or minimized. In cases where the standby position is surrounded by walls, the at least one part placed at an end of the standby position (near the walls) may be raised in a direction away from the walls, so that interference between the holding device and the walls can be avoided. Therefore, the at least one part in the standby position can be raised without fail.

According to the present invention, thanks to the measuring device provided in the part feeder to measure the thickness of the at least one part held in suspension on the rod of the holding device, any irregular parts different in thickness from the regular parts can be detected during the process of feeding the parts from the standby position to the predetermined position, so that the regular parts alone can be fed to the predetermined position. That is, an irregular part different in thickness from regular parts can be excluded from the parts to be fed to the predetermined position, so that a temporary halt in a subsequent step for removing the irregular part can be avoided. Consequently the production efficiency can be improved.

### BRIEF DESCRIPTION OF THE DRAWINGS

The above aspects, other advantages and further features of the present invention will become more apparent by describing in detail illustrative, non-limiting embodiments thereof with reference to the accompanying drawings, in which:

FIG. 1 is a plan view of a part feeder according to an exemplary embodiment of the present invention;

FIG. 2 is a front elevation of a holding device provided in the part feeder;

FIG. 3 is a section view taken along line A-A of FIG. 2;

FIG. 4A is a front elevation of the holding device holding connecting rods in suspension;

FIG. 4B is a side elevation of the holding device of FIG. 4A;

FIG. 5 shows the holding device with a detection unit detecting connecting rods in a dunnage;

FIG. 6A is a plan view of a measuring device provided in the part feeder;

FIG. 6B is a side elevation of the measuring device of FIG. 6A;

FIG. 6C is a section view taken along line B of FIG. 6B;

FIG. 7A is a front elevation of the holding device that is going to carry connecting rods in the leftmost row, with a holding rod inserted through the connecting rods; and

FIG. 7B is a front elevation of the holding device that is going to carry connecting rods in the rightmost row, with a holding rod inserted through the connecting rods.

### DETAILED DESCRIPTION OF THE EXEMPLARY EMBODIMENTS

A detailed description of exemplary embodiments of the present invention will be given with reference made to the drawings where appropriate.

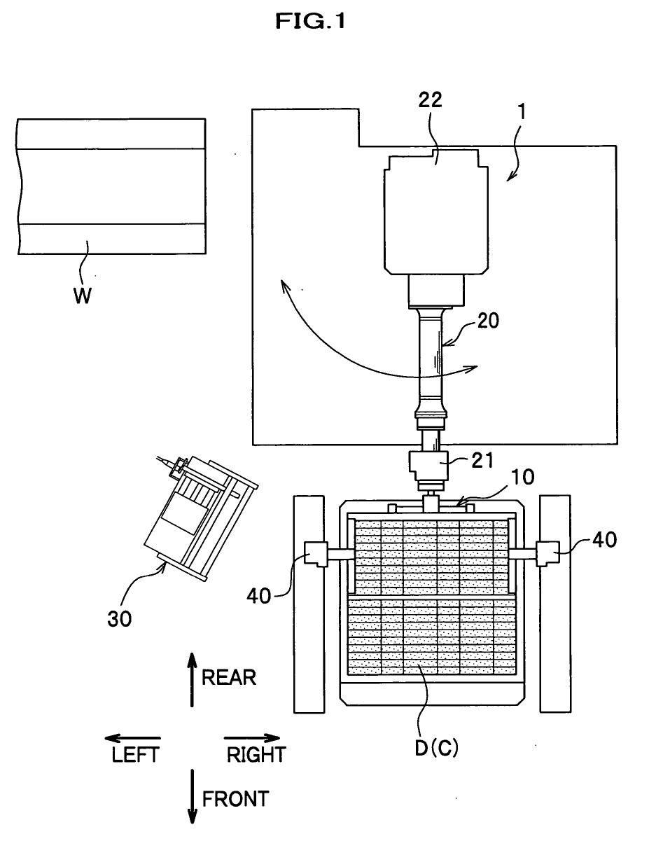

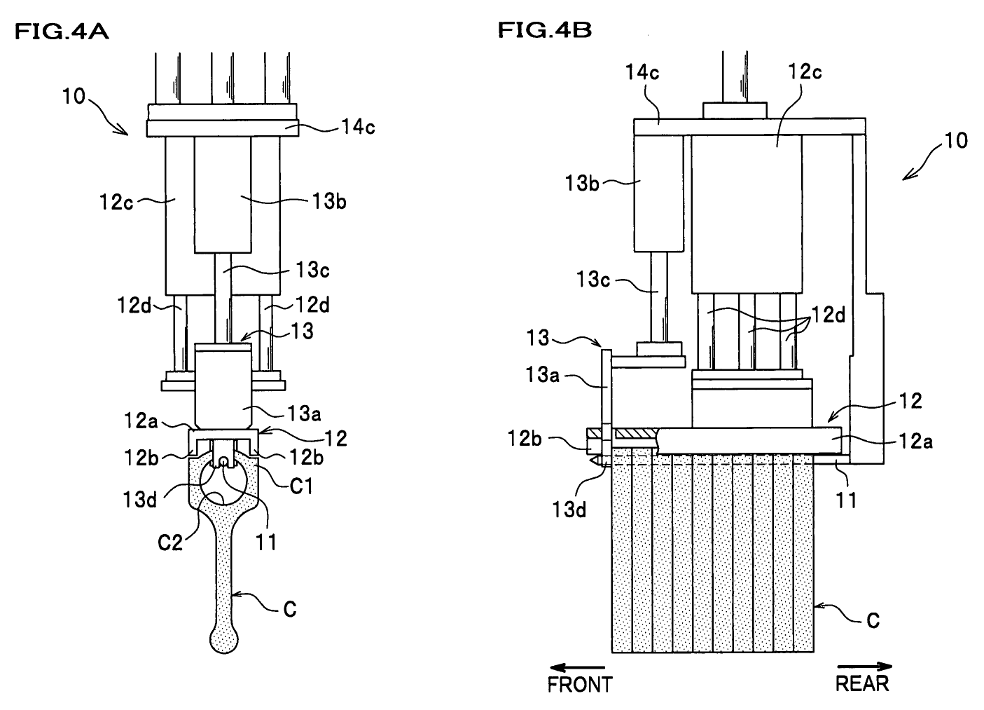

In the following description, a part feeder consistent with the present invention is exemplified by a part feeder 1 as shown in FIG. 1 for feeding connecting rods C placed in a dunnage D (standby position) to a walking beam W (a conveyor provided in a predetermined position). Connecting rod C is, as shown in FIGS. 4A and 4B, a long member for use in an automotive engine or the like. The connecting rod C has a big end in which a through hole C2 is provided.

[Part Feeder]

The part feeder 1 includes a holding device 10, a robot arm 20 and a measuring device 30, as shown in FIG. 1. The holding device 10 holds a plurality of connecting rods C placed in the dunnage D. The robot arm 20 is a transport mechanism adapted to move the holding device 10 to a predetermined position. The measuring device 30 is adapted to measure a totalized thickness of the plurality of connecting rods C held by the holding device 10.

[Holding Device]

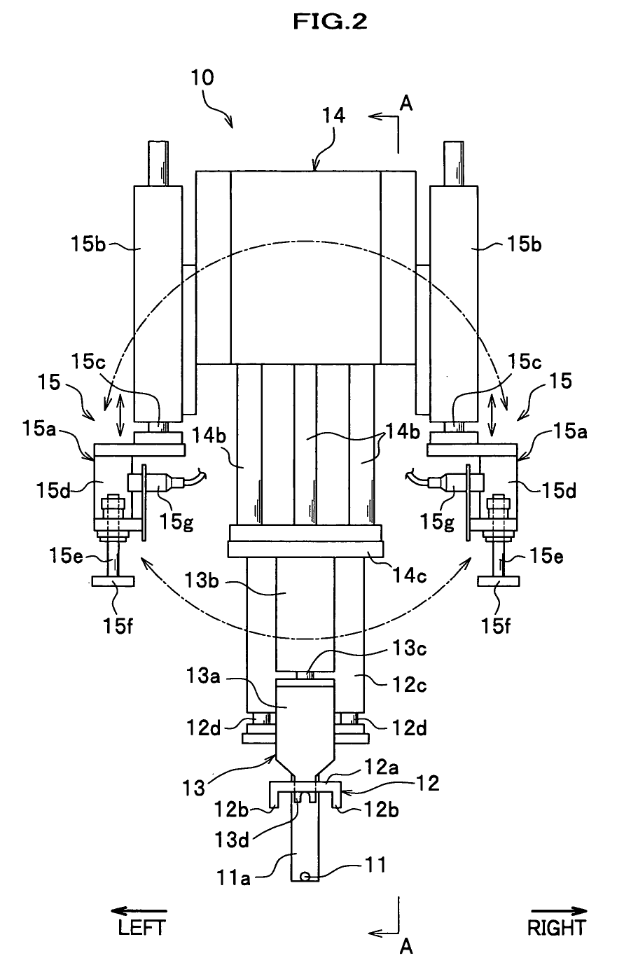

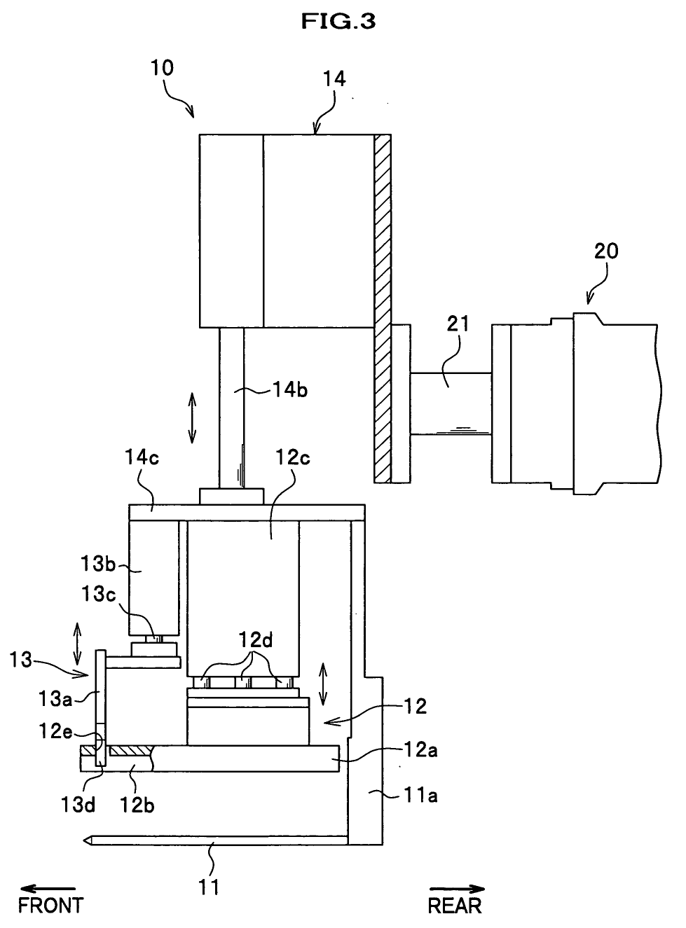

The next discussion focuses on the holding device 10 in greater detail. In the following description, the terms ‘front’ and ‘rear’ refer to the directions indicated by arrows labeled ‘FRONT’ and ‘REAR’ in FIG. 3, and the terms ‘right’ and ‘left’ refer to the directions indicated by arrows labeled ‘RIGHT’ and ‘LEFT’ in FIG. 2. Similarly, the terms ‘up’ and ‘down’, or ‘vertical(ly)’ refer to the directions toward the top and bottom of these drawings. It is however to be understood that the directions are defined relative to the holding device 10 and referred to as such for convenience of explanation. Referring to FIGS. 2 and 3, the holding device 10 includes a holding rod 11, an antisway mechanism 12, a stopper 13, an upper cylinder 14, and a pair of detection units 15. The holding rod 11 is a bar-like member used to hold connecting rods C in suspension. The antisway mechanism 12 includes a proximity member 12a disposed above the holding rod 11 and configured to move up and down. The stopper 13 includes a shutter 13a disposed above a front end of the holding rod 11 and configured to move up and down. The upper cylinder 14 is attached to a distal-end part 21 of the robot arm 20 and configured to vertically move and support the holding rod 11, the antisway mechanism 12 and the stopper 13 at a predetermined elevation. The detection units 15 are attached to the right and left sides of the upper cylinder 14, respectively.

To be more specific, a rear side of the upper cylinder 14 is attached to the distal-end part 21 of the robot arm 20, as shown in FIG. 1, and thus the upper cylinder 14 is supported by the robot arm 20. Three telescopically retractable rods 14b retractably protrude downward from the upper cylinder 14 as in FIGS. 2 and 3, and a support plate 14c, which is disposed in a horizontal position, is attached to lower ends of the retractable rods 14b. As the retractable rods 14b retracts and protrudes, the support plate 14c moves up and down.

The holding rod 11 is a bar-like member of circular cross section which is disposed in a horizontal position and in a front-rear direction. A rear end of the holding rod 11 is attached to a front side of a lower-end portion of a support bracket 11a which is disposed vertically extending from a rear-end portion of the support plate 14c. An outer cylindrical surface of the holding rod 11 is formed with a smooth surface.

The antisway mechanism 12, which is disposed above the holding rod 11, includes a proximity member 12a provided along the length of the holding rod 11, and an antisway cylinder 12c provided at a bottom side of the support plate 14c of the upper cylinder 14.

The proximity member 12a is shaped generally like a flat plate extending in the front-rear direction, with flanges 12b projecting downward from the right and left edges of the flat plate. To a top side of the proximity member 12a is attached lower ends of six telescopically retractable rods 12d which retracts and protrudes to move the proximity member 12a up and down above the holding rod 11. The distance between the flanges 12b of the proximity member 12a is designed such that the positions of the flanges 12b correspond to right and left marginal areas of a top end face of each connecting rod C held in suspension on the holding rod 11 (see FIG. 4A).

The stopper 13 includes a shutter 13a and a stopper cylinder 13b. The shutter 13a is a vertical plate inserted through a slot 12e provided in a front-end portion of the proximity member 12a of the antisway mechanism 12, and sides of the shutter 13a face toward the front and rear directions, respectively. The stopper cylinder 13b is attached to a bottom side of the support plate 14c of the upper cylinder 14. A telescopically retractable rod 13c of which a lower end is attached to the upper end of the shutter 13a projects downward from the stopper cylinder 13b. As the retractable rod 13c is caused to retract and protrude, the shutter moves up and down through the front-end portion (through the slot formed therein) of the proximity member 12a. When the shutter 13a is moved down, a lower end 13d thereof comes in contact with a front-end portion of the holding rod 11. The lower end 13d of the shutter 13a has a semicircular recess into which an upper surface of the holding rod 11 is fitted when the shutter 13a is moved down.

A description is now given of how the holding device 10 holds the connecting rods C. The holding device 10 is, as shown in FIGS. 4A and 4B, adapted to hold a plurality of connecting rods C in suspension on the holding rod 11, with the holding rod 11 inserted through the through holes C2 provided in the big ends C1 of the connecting rods C. The proximity member 12a of the antisway mechanism 12 is moved down to a position where the flanges 12b of the proximity member 12a is in close proximity to the right and left marginal areas of the top end face of each connecting rod C, so that the flanges 12b come in contact with the top end face to restrict the swaying motion of the connecting rods C. The shutter 13a of the stopper 13 is moved down until the lower end 13d of the shutter 13a comes in contact with the front-end portion of the holding rod 11, so that the connecting rods C held in suspension on the holding rod 11 are prevented from falling out of the holding rod 11.

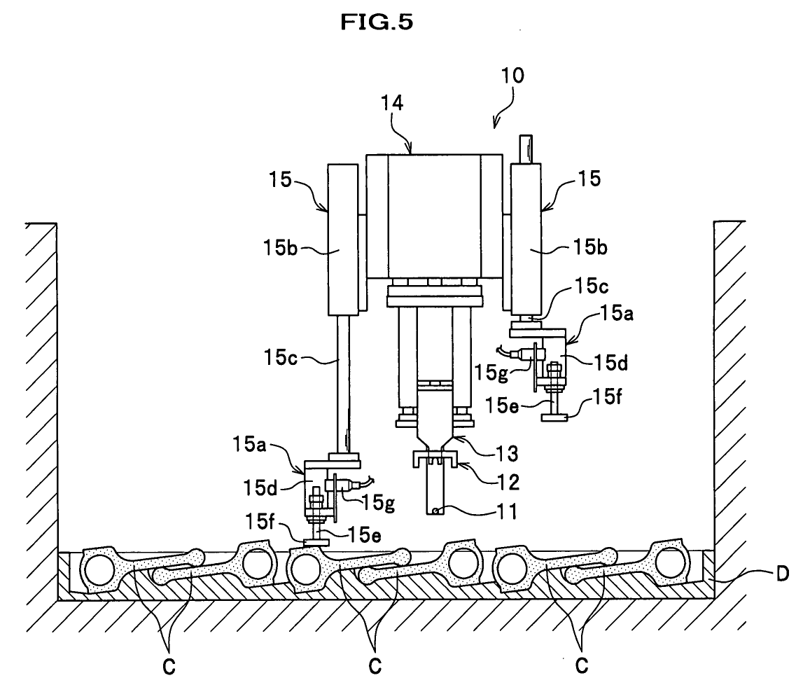

The detection unit 15 is described in more detail. Two units of detection units 15 for detecting connecting rods C placed in the dunnage D as shown in FIG. 5 are attached to the right and left sides of the upper cylinder 14, respectively. The right and left detection units 15 have substantially the same construction, and thus a duplicate description will not be given.

The detection unit 15 includes, as shown in FIG. 2, a detector 15a and a detector cylinder 15b. The detector cylinder 15b is attached to a side of the upper cylinder 14. The detector 15a is attached to a lower end of a telescopically retractable rod 15c configured to project downward from the detector cylinder 15b. As the retractable rod 15c retracts and protrudes, the detector 15a moves up and down.

A vertically disposed sensor rod 15e is attached to a frame 15d of the detector 15a in such a manner that the sensor rod 15e can be moved up and down. A horizontally disposed sensor plate 15f is attached to a lower end of the sensor rod 15e. A proximity sensor 15g is attached to the frame 15d of the detector 15a. The proximity sensor 15g is configured to detect an approach of an upper end of the upwardly moving sensor rod 15e.

A description is now given of how the detection unit 15 detects a connecting rod C in the dunnage D. As shown in FIG. 5, the holding device 10 is positioned above the dunnage D in which connecting rods C are to be placed. The detector 15a of the detection unit 15 is then moved down and stopped at a predetermined position. If the sensor plate 15f of the detector 15a comes in contact with a connecting rod C, and thus pushes up the sensor rod 15e to such a position that the upper end of the sensor rod 15e comes in close proximity detectable by the proximity sensor 15g, then it is determined that at least one connecting rod C is placed in the dunnage D. On the other hand, if the sensor rod 15e is not pushed up when the detector 15a is stopped at the predetermined position and the upper end of the sensor rod 15e is not detected by the proximity sensor 15g, then it is determined that no connecting rod C is placed in the dunnage D.

[Robot Arm]

The next discussion focuses on the robot arm 20 in greater detail. The robot arm 20 has, as shown in FIG. 1, a base part 22 and a distal-end part 21, and the distal-end part 21 is configured to rotate about an axis of the robot arm 20 as well as to move up and down, right and left, and front and rear. The robot arm 20 is configured to horizontally swing on a pivot provided in the base part 22 to thereby move the holding device 10 attached to the distal-end part 21 from the standby position above the dunnage D to the predetermined position above the walking beam W. Since the distal-end part 21 is configured to rotate about the axis of the robot arm 20, the holding device 10 attached to the distal-end part 21 can be tilted in its entirety.

[Measuring Device]

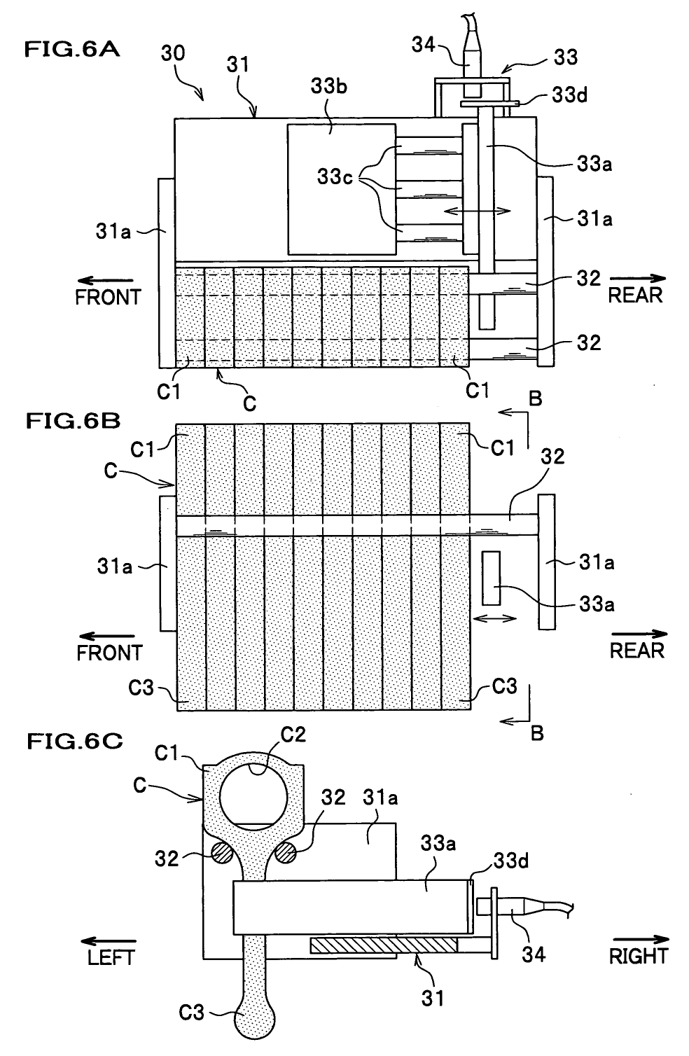

The next discussion focuses on the measuring device 30 in greater detail. The terms ‘right’ and ‘left’ used in describing the measuring device 30 refer to the directions indicated by arrows labeled ‘RIGHT’ and ‘LEFT’ in FIG. 6C, and similarly, the terms ‘front’ and ‘rear’ refer to the directions indicated by arrows labeled ‘FRONT’ and ‘REAR’ in FIGS. 6A and 6B.

The measuring device 30 is a device for measuring a totalized thickness of a plurality of connecting rods C held in suspension on the holding rod 11 of the holding device 10 (see FIG. 4B). As shown in FIG. 1, the measuring device 30 is located along a route which the holding device 10 takes when the holding device 10 is moved from the standby position above the dunnage D to the predetermined position above the walking beam W.

The measuring device 30 includes, as shown in FIGS. 6A through 6C, a base frame 31, two support rods 32 and a measuring element 33. The base frame 31 includes a pair of opposed stationary plates 31a facing to the front and rear directions and spaced with a predetermined distance left therebetween. The support rods 32 are disposed to extend between the stationary plates 31a. The measuring element 33 is configured to measure a totalized thickness of the connecting rods C held in suspension on the support rods 32.

Each support rod 32 is a bar-like member of circular cross section which is disposed in parallel with a front-rear direction. The two support rods 32 are spaced at a predetermined distance and disposed on a horizontal plane, at the right and at the left. The support rods 32 are adapted to support each connecting rod C conveyed and placed with the holding device 10 (see FIG. 4B). Each connecting rod C is inserted, with its sides facing to the front and rear directions (i.e., its thickness direction oriented in the front-rear direction), from its small end C3 into a gap between the support rods 32. Since the big end C1 of each connecting rod C has a width greater than the gap between the support rods 32, the bottom face of its big end C1 is hooked on the support rods 32, so that the connecting rod C is held in suspension on the support rods 32. In this state, the frontmost connecting rod C is in contact with an inner side of the front stationary plate 31a. It is understood that illustration of the holding device 10 (see FIGS. 4A and 4B) is omitted in FIGS. 6A through 6C so as to clearly show the structure of the measuring device 30, and the holding rod 11 of the holding device 10 is, in actuality, inserted through the through holes C2 of the connecting rods C.

The measuring element 33 includes a movable plate 33a and a measurement cylinder 33b. The movable plate 33a is a vertical plate disposed inside of the rear stationary plate 31a. The measurement cylinder 33b is disposed at the right of the support rods 32 and is attached to the base frame 31. Three telescopically retractable rods 33c project from the measurement cylinder 33b toward the rearward, and the movable plate 33a is attached to rear ends of the retractable rods 33c. As the retractable rods 33c retract and protrude, the movable plate 33a moves toward the frontward and toward the rearward.

Since a left end portion of the movable plate 33a is located below the support rods 32, the connecting rods C held in suspension on the support rods 32 are sandwiched between the front stationary plate 31a of the base frame 31 and the movable plate 33a when the movable plate 33a is moved toward the frontward to bring the left end portion of the movable plate 33a into contact with the rearmost connecting rod C. The position of the movable plate 33a in contact with rearmost connecting rod C is supposed to exhibit a totalized thickness of the connecting rods C as a whole.

A measurement plate 33d extending wider in the front-rear direction is attached to a right end of the movable plate 33a, and a proximity sensor 34 is attached to the base frame 31. The proximity sensor 34 is configured to detect the measurement plate 33d.

A detection hole is provided at a predetermined position in the measurement plate 33d. If each of the connecting rods C has a regular thickness, then the detection hole comes to a position to be detected by the proximity sensor 34 when the movable plate 33a is brought into contact with the rearmost connecting rod C. Accordingly, the proximity sensor 34 fails to detect the measurement plate 33d when each of the connecting rods C has the regular thickness.

On the other hand, when any irregular connecting rod C different in thickness from the regular connecting rods C is included in the connecting rods C suspended on the support rods 32, the detection hole is deviated from the position to be detected by the proximity sensor 34, and thus the proximity sensor 34 detects the measurement plate 33d.

[Part Feeding Process]

A description will be given of a process or method of feeding connecting rods C placed in the dunnage D (standby position) to the walking beam W (predetermined position), using a part feeder 1 as describe above (see FIG. 1).

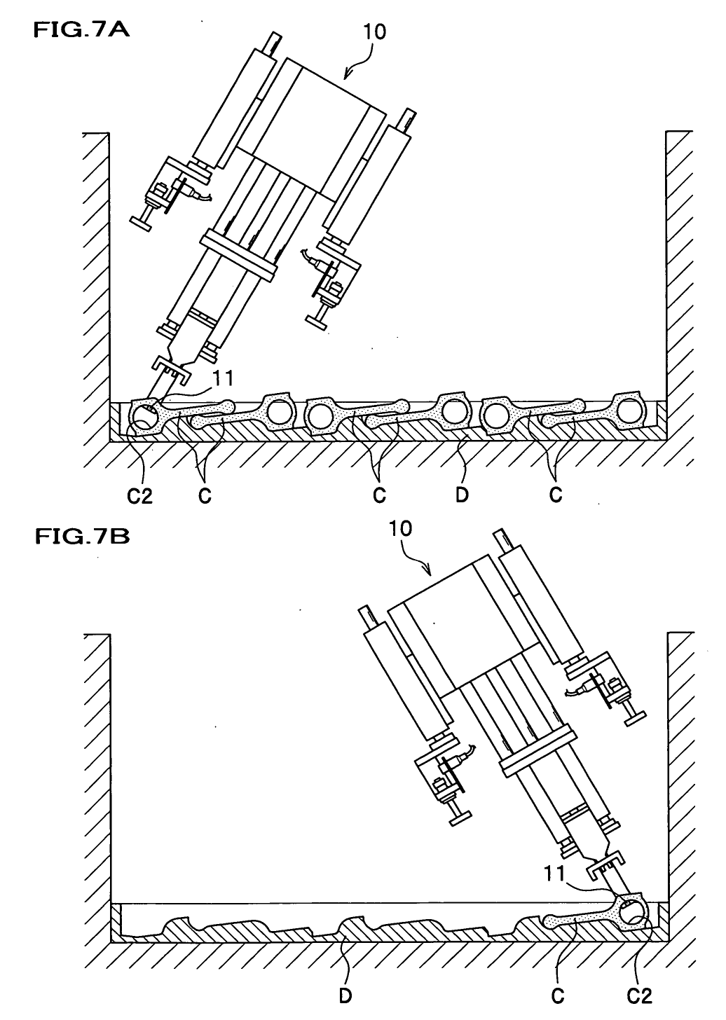

FIGS. 7A and 7B show a holding device 10 of the part feeder 1 according to the present embodiment, with connecting rods C held in suspension. FIG. 7A is a front elevation of the holding device 10 that is going to carry connecting rods C in the leftmost row, with a holding rod 11 inserted through the connecting rods C, and FIG. 7B is a front elevation of the holding device 10 that is going to carry connecting rods C in the rightmost row, with a holding rod 11 inserted through the connecting rods C. Operations of the holding device 10, robot arm 20 and measuring device 30 are configured to be automatically executed by a predetermined set of programs under control of a control unit (not shown).

First, as shown in FIG. 1, the holding device 10 is moved to a position above the dunnage D; then, as shown in FIG. 5, the detector 15a of the detection unit 15 is lowered to detect the presence or absence of the connecting rods C. Detection of the connecting rods C in the dunnage D serves to prevent failure to feed the connecting rod C remaining in the dunnage D.

In the present embodiment, a stack of multiple dunnages D are carried into the standby position and sequentially used one after another from top to bottom, and thus the connecting rods C are taken out from the dunnages D different in height. Therefore, every time an emptied dunnage D is removed from the stacked dunnages D, the lowering distance of the detector 15a should increment. For that purpose, in this embodiment, there is provided a pair of measuring devices 40 for measuring the height of the stacked dunnages D, and the lowering distance of the detector 15a is determined based upon the height of the top dunnage D as measured by the measuring devices 40.

Subsequently, as shown in FIG. 7A, the holding rod 11 of the holding device 10 is inserted through the through holes C2 of a plurality of the connecting rods C arranged in the front-rear direction, to suspend the plurality (ten in this embodiment) of connecting rods C.

In the present embodiment, when the holding device 10 holds, hoists and suspends a connecting rod C laid in the dunnage D, the holding device 10 is tilted with the holding rod 11 kept substantially horizontal, and then the holding rod 11 of thus-tilted holding device 10 is inserted through the through holes C2 of the connecting rods C at the outset. Then, the holding device 10 is caused to tilt up so that the position of the holding device 10 in its entirety is restored into an upright position while the holding device 10 is moved up, so that the big ends (having the through holes C2) of the connecting rods C are obliquely raised. In this way, the connecting rods C are hoisted in a slanting upward direction so that the connecting rods C gradually rise with their small ends unmoved and are lifted up to a vertically suspended position.

Accordingly, the motion of the connecting rods C made while it is being brought into the vertically suspended position becomes smooth and fluid, and thus the swaying motion of the connecting rods C held in suspension can be reduced or minimized. Even if the dunnage D is surrounded by vertical walls, the connecting rods C placed at an end of the standby position (i.e., near the walls) may be raised in a direction away from the walls, so that interference between the holding device 10 and the vertical walls can be avoided. Therefore, the connecting rods in the dunnage D can be raised into a suspended position without fail. In FIG. 7A, the holding rod 11 is inserted through the connecting rods C in the leftmost row to raise the connecting rods C into a suspended position. In FIG. 7B, the holding rod 11 is inserted through the connecting rods C in the rightmost row to raise the connecting rods C into a suspended position. Likewise, when the holding device 10 is going to carry the connecting rods C in a middle row, though not shown, the connecting rods C are held by the tilted holding device 10, and are raised in a slanting upward direction so that the connecting rods C gradually rise with their small ends and are lifted up to a vertically suspended position.

In the next step, as shown in FIGS. 4A and 4B, the proximity member 12a of the antisway mechanism 12 is moved down toward the plurality of connecting rods C suspended on the holding rod 11 so that the flanges 12b of the proximity member 12a are disposed in close proximity to the right and left marginal areas of the top end face of each connecting rod C, while the shutter 13a of the stopper 13 is moved down until the lower end 13 (semicircular recess formed therein) comes in contact with the front-end portion of the holding rod 11.

Thereafter, as shown in FIG. 1, the robot arm 20 is caused to horizontally swing on a pivot provided in the base part 22 to thereby cause the holding device 10 attached to the distal-end part 21 to move toward a position above the measuring device 30, so that the holding device 10 is stopped at the position above the measuring device 30. During this operation, the connecting rods C suspended on the holding rod 11 of the holding device 10 are brought to the distal end (toward front end) of the holding rod 11 by the centrifugal force generated when the holding rod 11 is swung horizontally. The proximity member 12a of the antisway mechanism 12 is in close proximity to but not in contact with the top end faces of the connecting rods C, and thus the connecting rods C are not pressed against the holding rod 11. Therefore, the connecting rods C can slide on the holding rod 11 and move smoothly toward the distal end of the holding rod 11.

Since the shutter 13a of the stopper 13 is in contact with the front-end portion of the holding rod 11, the connecting rods C are prevented from falling out from the front end of the holding rod 11.

After the holding device 10 is stopped at a position above the measuring device 30, the holding device 10 is lowered, and the connecting rods C are inserted, as shown in FIGS. 6A-6C, through a gap between the support rods 32 of the measuring device 30 to hold the connecting rods C in suspension on the support rods 32. At this stage, the proximity member 12a of the antisway mechanism 12 is in close proximity to the top end faces of the connecting rods C held in suspension on the holding rod 11 of the holding device 10 as shown in FIGS. 4A and 4B. Therefore, when the connecting rods C receive an action which would cause the connecting rods C to sway from side to side, the flanges 12b of the proximity member 12a come in contact with the top end faces of the connecting rods C, and thus prevent the connecting rods C suspended on the holding rod 11 from swaying too much. Accordingly, it is possible to insert the connecting rods C through the support rods 32 without worrying about the swaying motion of the connecting rods C (without the need for waiting until the connecting rods C stops swaying).

In the measuring device 30, the measurement plate 33d is moved toward the frontward and the left-end portion of the movable plate 33a is brought into contact with the rearmost connecting rod C, as shown in FIGS. 6A-6C. As a result, the connecting rods C is sandwiched between the front stationary plate 31a of the base frame 31 and the movable plate 33a, and the position of the movable plate 33a can be used to indicate the totalized thickness of the connecting rods C.

If the detection hole formed in the measurement plate 33d of the movable plate 33a comes to a position to be detected by the proximity sensor 34 and the measurement plate 33d is not detected by the proximity sensor 34 when the left end portion of the movable plate 33a is brought into contact with the rearmost connecting rod C, the control unit (not shown) determines that each connecting rod C has a regular thickness.

On the other hand, if the detection hole of the measurement plate 33d is deviated from the position to be detected by the proximity sensor 34 and the measurement plate 33d is detected by the proximity sensor 34, the controller determines that at least one irregular connecting rod different in thickness from the regular connecting rods C is included in the connecting rods C.

When the holding device 10 is moved to a position above the measuring device 30, the connecting rods C are centrifugally brought together at the distal end (toward front end) of the holding rod 11, as shown in FIG. 4B. Therefore, as no clearance is left between adjacent connecting rods C when the thickness of the connecting rods C as a whole is measured, the totalized thickness of the connecting rods can be measured with accuracy.

If the controller determines that any irregular connecting rod C different in thickness from the regular connecting rods C is included, then such determination results may be displayed on the monitor or otherwise shown to an operator. In response to the shown results, the operator removes the irregular connecting rod C different in thickness from the regular connecting rods C.

Thereafter, the holding device 10 holds, hoists and suspends the connecting rods C. Then, the robot arm 20 is actuated to horizontally swing on a pivot provided in the base part 22 to move the holding device 10 attached to the distal-end part 21 toward the walking beam W. The shutter 13a of the stopper 13 (see FIGS. 4A and 4B) of the holding device 10 and the proximity member 12a of the antisway mechanism 12 are raised at a position above the walking beam W to discharge the connecting rods C from the front end of the holding rod 11 into the walking beam W.

As described above, the part feeder 1 according to the present embodiment is configured to hold a plurality of connecting rods C in suspension on the holding rod 11 of the holding device 10, with a measuring device 30 provided to measure a thickness of the connecting rods C held on the holding rod 11. In this configuration, any irregular connecting rod C different in thickness from the regular connecting rods can be detected during the process of feeding the connecting rods C from the dunnage D (standby position) to the walking beam W (predetermined position). Consequently, the regular connecting rods C alone can be fed to the walking beam W, and a temporary halt in a subsequent step for removing the irregular connecting rod C can be avoided, so that the production efficiency can be improved.

Although the exemplary embodiments of the present invention have been described above, the present invention is not limited to the above-described embodiments, and various modifications and changes may be made in the present invention without departing from the spirit and scope thereof. For example, in the above-described embodiments, parts to be fed by the part feeder consistent with the present invention are exemplified by a plurality of connecting rods C, but it is to be understood that no limitations should be placed on the shape of each part and any part having a through hole through which the holding rod 11 of the holding device 10 can be inserted may be applied. Plurality of the parts is not requisite, though a plurality of parts (connecting rods C) are held in suspension on the holding rod 11 of the holding device 10 as shown in FIG. 4B in the above-described embodiments. A part feeder for feeding a single part in a single operation may fall within the scope of the present invention.

What is claimed is:

1. A part feeder for feeding at least one part having a through hole from a standby position to a predetermined position, comprising:
a holding device having a rod disposed in a horizontal position, wherein the holding device is adapted to hold the at least one part in suspension with the rod inserted through the through hole of the at least one part;
a transport mechanism adapted to move the holding device holding the at least one part in suspension from the standby position to the predetermined position; and
a measuring device adapted to measure a thickness of the at least one part held by the holding device.

2. The part feeder according to claim 1, wherein the transport mechanism includes means for causing the rod with the at least one part to be horizontally swung toward the measuring device, in a manner that centrifugally brings the at least one part to a distal end of the rod; and
wherein the thickness of the at least one part measured by the measuring device includes a totalized thickness of a plurality of the parts brought together at the distal end of the rod.

3. The part feeder according to claim 1, wherein the holding device includes a detection unit adapted to detect a part placed in the standby position.

4. The part feeder according to claim 2, wherein the holding device includes a detection unit adapted to detect a part placed in the standby position.

5. The part feeder according to claim 1, wherein the holding device includes an antisway mechanism adapted to come in close proximity to the at least one part held in suspension with the rod inserted through the through hole of the at least one part in order to prevent the at least one part from swaying.

6. The part feeder according to claim 2, wherein the holding device includes an antisway mechanism adapted to come in close proximity to the at least one part held in suspension with the rod inserted through the through hole of the at least one part in order to prevent the at least one part from swaying.

7. The part feeder according to claim 3, wherein the holding device includes an antisway mechanism adapted to come in close proximity to the at least one part held in suspension with the rod inserted through the through hole of the at least one part in order to prevent the at least one part from swaying.

8. The part feeder according to claim 4, wherein the holding device includes an antisway mechanism adapted to come in close proximity to the at least one part held in suspension with the rod inserted through the through hole of the at least one part in order to prevent the at least one part from swaying.

9. The part feeder according to claim 1, wherein the at least one part comprises a long member having a first end and a second end, and the through hole is provided at the first end of the long member; and
wherein the holding device includes means for raising the long member laid in the standby position in a slanting upward direction whereby the long member gradually rises with the second end unmoved and is lifted up to a vertically suspended position.

10. A method for feeding at least one part having a through hole from a standby position to a predetermined position, comprising the steps of:
holding the at least one part in suspension with a horizontally-disposed rod inserted through the through hole of the at least one part;
moving the at least one part held in suspension from the standby position to the predetermined position; and
measuring a thickness of the at least one part held in suspension.

11. The method according to claim 10, further comprising causing the rod with the at least one part to be horizontally swung in a manner that centrifugally brings the at least one part to a distal end of the rod, before the measuring step; and
wherein the measuring step comprises measuring a totalized thickness of a plurality of the parts brought together at the distal end of the rod.
